(19) United States
(12) Patent Application Publication
(10) Pub. No.: US 2007/0190382 A1
(43) Pub. Date: Aug. 16, 2007

(54) Hydrocarbon reformer system

(76) Inventor: Bernhard A. Fischer, Rochester, NY (US)

Correspondence Address: DELPHI TECHNOLOGIES, INC., M/C 480-410-202, PO BOX 5052, TROY, MI, 48007, US

(21) Appl. No.: 11/351,555

(22) Filed: Feb. 10, 2006

(51) Int. Cl. H01M 8/06; C01B 3/26; B01J 8/02

(52) U.S. Cl. 429/30; 422/211; 423/651

(57) ABSTRACT

A hydrocarbon reformer system for a fuel cell system comprising a feedstream delivery unit (FDU) and a hydrocarbon catalytic reformer (CR). The reformer includes a catalyst disposed in a housing. Ahead of the catalyst is the FDU including a mixing element in the shape of a cone for receiving any or all of air, hydrocarbon fuel, anode tailgas, and steam. The cone has tangential entry slots for the reactants. Addition enclosures combine reactants prior to entry into the cone through the slots. Fuel is metered into the reactants in the enclosures. A manifold having a tangential entry for receiving reactants surrounds the cone. Swirl flow within the cone creates an intense low-pressure zone within the cone, causing turbulence and mixing of the reactants. Homogenized reactants leave the cone in a sheet flow nearly uniform in temperature that enters the catalyst and allows uniform catalysis over the entire catalyst surface.

### TECHNICAL FIELD

The present invention relates to hydrocarbon reformers for producing fuel for fuel cells; more particularly, to such a reformer that utilizes the anode tailgas stream from an associated fuel cell system; and most particularly, to a reformer system having a shaped chamber ahead of the reformer catalyst for passive, turbulent mixing of fuel, anode tailgas, air, and/or steam.

### BACKGROUND OF THE INVENTION

Partial catalytic oxidizing (CROx) reformers are well known in the art as devices for converting hydrocarbons to reformate containing hydrogen (H₂) and carbon monoxide (CO) as fuel for fuel cell systems, and especially for solid oxide fuel cell (SOFC) systems.

Because a fuel cell is a relatively inefficient combustor, the anode tail gas stream exiting an SOFC stack is typically rich in H₂O, CO₂, and also a substantial amount of residual CO and H₂. Venting or burning the anode tail gas is wasteful and directly affects the overall fuel efficiency of the fuel cell system. To increase overall fuel efficiency, it is known in the art to recycle a portion of the anode tail gas back into the reformer, which improves efficiency in two ways: a) by passing the residual hydrogen and carbon monoxide through the stack again, and b) by providing beneficial heat from the stack to the reformer. Recycling anode tail gas through the stack allows apparent reformer efficiencies in excess of 100% when calculated as the ratio of reformer outlet power to fuel inlet power. Further, when temperatures in the reformer are sufficiently high, fuel reforming may proceed adiabatically through decomposition of fuel with water and carbon dioxide without addition of outside oxygen in the form of air. Reforming efficiencies greater than 99% of the possible thermodynamic efficiency are calculated as possible, given sufficient heat recovery into the entering reactants from the stack and reformer catalyst.

Although it is known in the art to inject tailgas into the air stream and fuel stream being supplied to a reformer, the prior art has not focused on optimizing the mixing of the various streams before sending the mixture into the reformer, nor on highly efficient heat extraction from the reformer catalyst. As a result, prior art mixtures are inhomogeneous, leading to large areal variations in reformer catalysis, carbon buildup in the reformer, extreme thermal stresses within the catalyst, and inefficient reformate generation.

Further, prior art reformer arrangements have not focused on optimizing not only steady state operation but also on the temporary but important periods of system start-up and transition to steady-state.

What is needed is a hydrocarbon reformer system that provides very high fuel efficiency; can be started up very rapidly without carbonizing of the catalyst; improves thermal efficiency by internally recycling heat of catalysis; and is operable over a wide range of reformate demand.

It is a principal object of the present invention to improve fuel efficiency.

It is a further object of the invention to reduce thermal stress and carbon buildup within a reformer catalyst and to thereby increase the working lifetime thereof.

### SUMMARY OF THE INVENTION

Briefly described, a hydrocarbon reformer system in accordance with the invention comprises two main sections: a feedstream delivery unit (FDU) and a hydrocarbon catalytic reformer (CR). The reformer includes a hydrocarbon-reforming catalyst disposed in a reforming chamber in an elongate housing. Ahead of the catalyst is the FDU including a mixing chamber for receiving any or all of air, hydrocarbon fuel, anode tailgas, and steam. The mixing chamber includes a mixing element, preferably cone shaped, having entry slots for reactants formed tangentially to the inner wall of the mixing cone. On the outer surface of the mixing element are structures for combining reactants prior to entry into the mixing element through the tangential slots. Fuel is metered from a fuel manifold into the reactants in the addition structures to form a combined feedstream. The housing further includes a plenum chamber for receiving reactants to be mixed with the fuel. The entrance to the plenum chamber preferably is tangential to the chamber wall to provide a pre-swirl of the reactants.

In operation, reactants other than fuel enter the plenum chamber and wash over the outer surface of the mixing element, which is hot from radiational exposure to the face of the catalyst, thereby recovering waste process heat and pre-heating the reactants. The reactants enter the addition structures wherein they combine with injected fuel to form a combined feedstream which then enters tangentially of the mixing element. The resulting vortical flow within the element spreads and expands along the inner element surface, creating an intense low-pressure zone within the element.

Combined reactants leaving the periphery of the element are drawn back axially into the low-pressure zone in the element, causing extreme turbulence and mixing of the reactants. Homogenized reactants leave the element in a sheet flow nearly uniform in temperature, velocity, and composition that enters the catalyst and allows uniform catalysis over the entire catalyst surface.

Preferably, at start-up the fuel/air mixture in the element is leaned out by reducing the injection of fuel through an apex jet and increasing the amount of air, creating a combustible mixture which is ignited and then continues to propagate. The hot combustion gases raise the catalyst to reforming temperature in a few seconds. Combustion in the element is then quenched by cessation of fuel flow for a short period, after which the fuel/air ratio is adjusted for optimum reforming.

### BRIEF DESCRIPTION OF THE DRAWINGS

The present invention will now be described, by way of example, with reference to the accompanying drawings, in which: FIG. 1 is a schematic diagram of a solid oxide fuel cell system including a hydrocarbon reformer system in accordance with the invention;

FIG. 2 is a cross-sectional view of an exemplary hydrocarbon reform system in accordance with the invention;

FIG. 3 is a plot of flow vectors within the conical mixing chamber shown in FIG. 2; and FIG. 4 is a schematic cross-sectional view taken along line 4-4 in FIG. 2.

### DESCRIPTION OF THE PREFERRED EMBODIMENTS

Referring to FIG. 1, an SOFC system 10 in accordance with the invention comprises an SOFC stack 12 having an anode inlet 14 for reformate 16 from a CPOx reformer system 18 in accordance with the invention; an anode tail gas outlet 20; an inlet 22 for heated cathode air 24 from a cathode air heat exchanger 26; and a cathode air outlet 28. SOFC system 10 is useful, for example, as an auxiliary power unit (APU) in a vehicle 11.

A first portion 29 of anode tail gas 30 and spent cathode air 32 are fed to a burner 34, the hot exhaust 35 from which optionally is passed through a reformer heat exchanger 37, to partially cool the reformer, and through cathode air heat exchanger 26 to heat the incoming cathode air 36, received from process air blower 58 and air flow metering system 38. A second portion 40 of anode tail gas 30 is diverted ahead of burner 34 to an anode tail gas pump 44 which directs cooled portion 41 into an entrance to a feedstock delivery unit (FDU) 46 ahead of a catalytic reforming unit 47 in reformer system 18. Thus residual hydrocarbons in the anode tail gas are exposed to reforming for a second time, and heat is recovered in both the reformer and the cathode air heater. FDU 46 is further supplied with fuel 48 via a fuel tank 50, a fuel pump 52, and a fuel flow metering system 54. FDU 46 is further supplied optionally with air 56 via process air blower 58 and air flow metering system 60. Blower 58 and pump 44 are controlled by controller group 61 which, in the example shown, includes a power bus conditioner, an APU controller and various sensors and actuators.

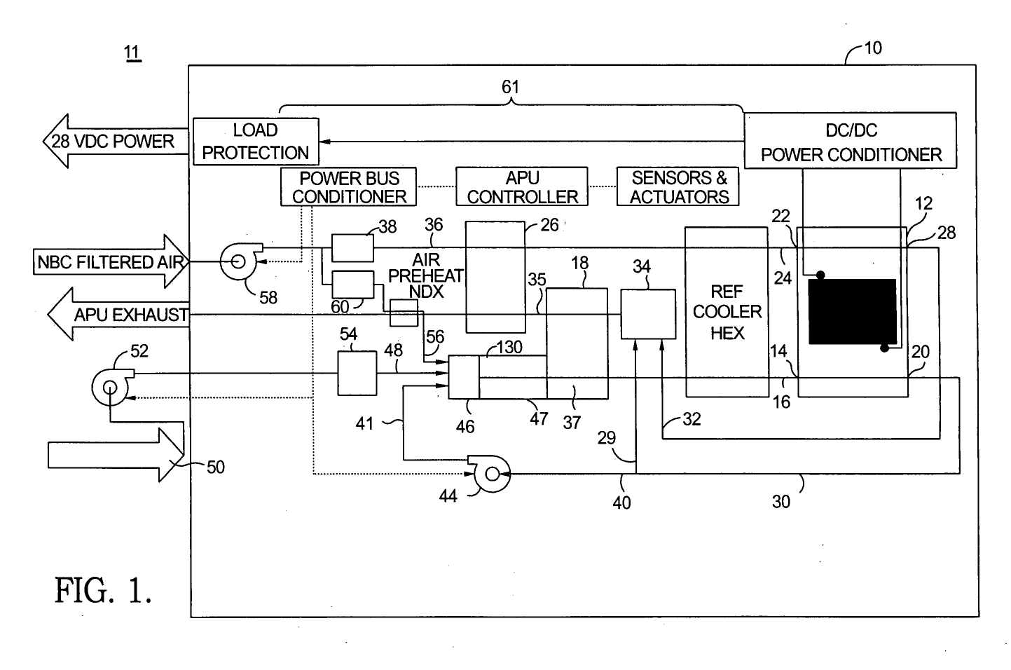

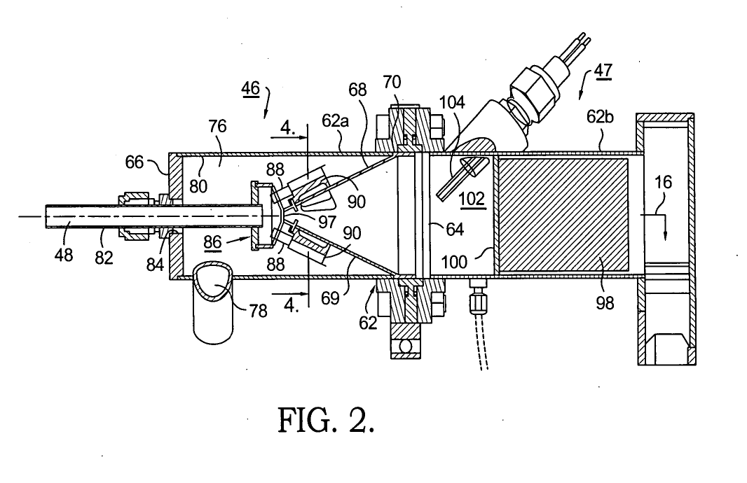

Referring to FIGS. 2 through 4, hydrocarbon reformer system 18 comprises a housing 62, preferably cylindrical and preferably formed in two connectable sections 62a, 62b embracing a flash-back screen 64 across the housing that prevents spontaneous combustion in the feed end of the system during steady-state operation. Housing 62a defines FDU 46 and housing 62a defines reforming unit 47.

FDU 46 comprises housing 62a which is closed at outer end 66 and contains a mixing element 68, preferably in the shape of a cone, Open toward catalytic reforming unit 47. Mixing element 68 is sealed to housing 62a along a circular joint 70. Near the apex of mixing element 68, at least one slot 72, and preferably two such slots as shown in FIG. 4, is formed through the wall of mixing element 68 such that material flowing into the element is introduced generally tangential of the inner surface 74 of mixing element 68. Surrounding mixing element 68 is a manifold 76 formed within housing 62a for receiving one or more gaseous reactants, such as anode tail gas 41 and optionally air 56, via an entry port 78 formed preferably such that the reactants are introduced generally tangential of the inner surface 80 of housing 62a whereby the gaseous reactants are caused to at least partially mix.

A fuel supply line 82 enters manifold 76 via port 84 formed in housing end 66 and terminates in a fuel manifold 86 for receiving fuel 48. Manifold 86 is connected via distributors 88 to an addition enclosure 90 attached to mixing element 68 at each of slots 72, as shown in FIGS. 2 and 4. Each addition enclosure 90 comprises a manifold chamber 92 having at least one outlet jet or slot 94, and preferably a plurality thereof, extending into a combining chamber 96.

Optionally, an axial pilot fuel port 97 may be provided at the apex of mixing element 68 in communication with fuel manifold 86 for selectively injecting fuel axially into mixing element 68 as may be desired.

Presently preferred hydrocarbon fuels for SOFC system 10 are either gaseous, such as methane, propane, natural gas, and the like, or are readily volatilized via heat exchange (not shown) prior to being introduced into FDU 46.

Still referring to FIG. 2, reforming unit 47 comprises a catalytic bed 98 capable of reforming hydrocarbons to a reformate 16 containing at least hydrogen and carbon monoxide, as is well known in the prior art. Bed 98 may be covered by a porous shield 100. Preferably, a catalyst antechamber 102 is provided for receiving a combustion ignitor 104 as is known in the prior art and described hereinbelow.

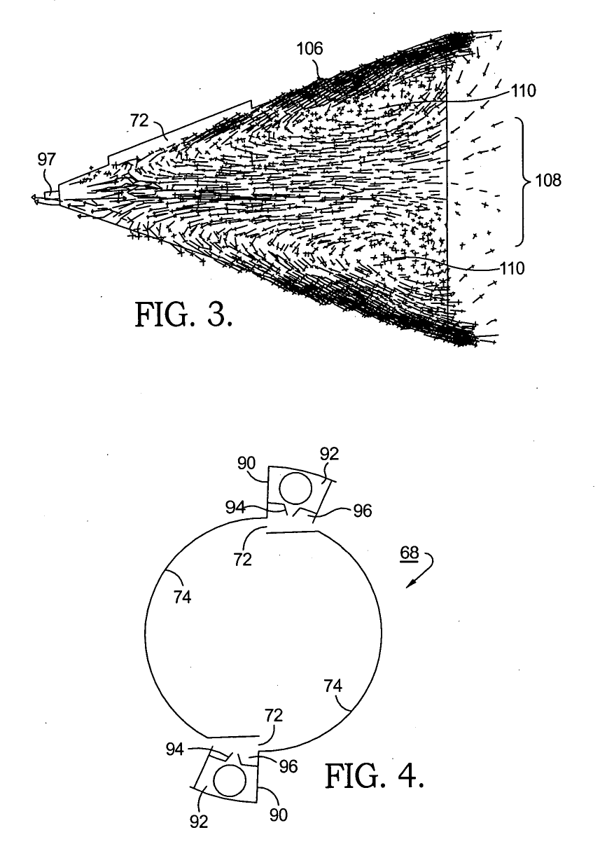

Referring to FIG. 3, it will be seen that mixing element 68 is a conical swirl generator. Gaseous reactants entering element 68 from manifold 76 via the previously-described tangential slots 72 generate a vortical flow field 106 with vortex breakdown resulting in a high degree of recirculation 108 of reactants back into and around nodes 110 within the flow field and causing a high level of homogenization of reactants.

In operation during system start-up mode, mixing element 68 functions as a combustion chamber. Air and fuel are introduced into and combined in addition enclosures 90, and the feedstream combination is introduced into element 68 via slots 72 (and additional fuel via port 97) and is homogenized as just described. As the homogenized air/fuel mixture passes into antechamber 102 it is ignited by ignitor 104, the tip of which is immediately proximate screen 64, to form hot combustion gases in antechamber 102 that are then passed through catalyst bed 98. Upon the ignition, combustion also flashes back from antechamber 102 into mixing element 68 and continues spontaneously therein for a predetermined length of time, for example, about ten seconds, generating thereby a continuous flow of hot gases through catalyst bed 98 sufficient to bring the catalyst bed to reforming temperature. Combustion is extinguished by shutting off the flow of fuel for a brief period, for example, one second.

In operation during steady-state mode, fuel is provided to addition enclosures 90 and anode tailgas 41 is provided into FDU 46 via port 78. In exothermic reforming, air 56 is also supplied, and the fuel/air mixture is sufficiently lean that spontaneous combustion does not occur within either the mixing cone or the reformer. The combined air and tailgas are swirled in manifold 76, washing over the outer surface 69 of mixing element 68. Heat of reforming, radiated from catalyst bed 98, is absorbed by mixing element 68 and is conducted to outer surface 69 which is washed and cooled by the combined air and tailgas, thus recovering significant heat energy to preheat the entering air and tailgas, and providing a heat sink for catalyst bed 98. As overall temperature of the system increases, the flow of air 56 may be reduced as reforming becomes more endothermic, utilizing the carbon dioxide and water content of the anode tailgas. Under conditions in which the tailgas water volume is insufficient, steam may be added to the mix (by conventional means not shown).

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A hydrocarbon reformer system, comprising
a) a reforming unit for reforming hydrocarbon fuel into reformate containing hydrogen and carbon monoxide, said reforming unit including a reforming catalyst bed; and
b) a feedstream delivery unit for homogenizing and tempering various reactants to be supplied to said catalytic reforming unit, said feedstream delivery unit including a mixing element wherein said various reactants are vertically mixed and recirculated.

2. The reformer system in accordance with claim 1 wherein said mixing element is in the shape of a cone.

3. A reformer system in accordance with claim 1 wherein said mixing element includes at least one entry slot formed in a surface thereof such that reactants entering said element through said slot are entered tangentially of an inner surface of said element.

4. A reformer system in accordance with claim 3 comprising a plurality of said entry slots.

5. A reformer system in accordance with claim 3 further comprising a combining chamber in fluid communication with said mixing element for combining hydrocarbon fuel with other of said reactants being supplied to said mixing element.

6. A reformer system in accordance with claim 3 further comprising a manifold surrounding an outer surface of said mixing element for supplying reactants to said entry slot.

7. A reformer in accordance with claim 6 wherein said manifold is cylindrical and has a tangentially-mounted entry port for said reactants.

8. A reformer system in accordance with claim 6 wherein said reactants are selected from the group consisting of air, anode tailgas, steam, and combinations thereof.

9. A reformer system in accordance with claim 1 further comprising an igniter disposed between said mixing element and said reforming catalyst bed.

10. A reformer system in accordance with claim 1 further comprising a fuel manifold in said feedstream delivery unit for supplying hydrocarbon fuel to said mixing element.

11. A solid oxide fuel cell system comprising a hydrocarbon reformer system, wherein said hydrocarbon reformer system includes
a reforming unit for reforming hydrocarbon fuel into reformate containing hydrogen and carbon monoxide, said reforming unit including a reforming catalyst bed, and
a feedstream delivery unit for homogenizing and tempering various reactants to be supplied to said catalytic reforming unit, said feedstream delivery unit including a mixing element wherein said various reactants are vertically mixed and recirculated.

12. A method for providing a homogeneous feedstream mixture of hydrocarbon fuel and other reactants to a hydrocarbon catalytic reformer, comprising the steps of:
a) providing a housing including a mixing element opening toward said reformer, said mixing element having a plurality of tangential slots formed in communication between outer and inner surfaces of said element;
b) combining said hydrocarbon fuel and said various other reactants into a feedstream combination outside of said outer surface of said element;
c) injecting said feedstream combination through said slots into said element tangentially along said inner wall of said element to form a vortical circulation within said element wherein said feedstream combination is homogenized; and
d) providing said homogenized feedstream combination to said hydrocarbon catalytic reformer.

13. A method in accordance with claim 12 wherein said other reactants are selected from the group consisting of air, anode tailgas, steam, and combinations thereof.

14. In a hydrocarbon reforming system having a feedstream delivery unit and a catalytic reforming unit for reforming hydrocarbon fuel and other reactants to produce a hydrogen-containing reformate,
wherein the feedstream delivery unit includes a mixing element opening toward the catalytic reforming unit, the mixing element having a plurality of tangential slots formed in communication between outer and inner surfaces of the element, and
wherein the catalytic reforming unit includes a catalyst bed requiring a minimum temperature for catalytic reforming of hydrocarbons to generate hydrogen-containing reformate,
a method for operating the hydrocarbon reforming system comprising the steps of:
a) starting up said system by
i) combining said hydrocarbon fuel and said other reactants outside of said mixing element to form a feedstream combination,
ii) injecting said feedstream combination through said slots into said element tangentially along said inner wall of said element to form a vortical circulation within said element wherein said feedstream combination is homogenized,
iii) igniting said homogenized feedstream combination to produce hot combustion gases, and
iv) passing said hot combustion gases through said catalyst bed to raise the temperature thereof to at least said minimum reforming temperature; and
b) operating said system at steady state by
i) extinguishing combustion in said mixing element,
ii) continuing said combining and injecting steps, and
iii) adjusting flow rates of said hydrocarbon fuel and said other reactants for optimal hydrocarbon reforming.
